(19) United States
(12) Patent Application Publication
(10) Pub. No.: US 2008/0067056 A1
(43) Pub. Date: Mar. 20, 2008

(54) Method and device for controlled release of biomolecules and nanoparticles

(75) Inventors: Peter C. Searson, Baltimore, MD (US); Nirveek Bhatacharjee, Baltimore, MD (US); Prashant Mali, Baltimore, MD (US)

Correspondence Address: LARRY J. GUFFEY, WORLD TRADE CENER - SUITE 1800, 401 EAST PRATT STREET, BALTIMORE, MD, 21202, US

(73) Assignee: The Johns Hopkins University, Baltimore, MD (US)

(21) Appl. No.: 11/804,964

(22) Filed: May 21, 2007

Related U.S. Application Data
(60) Provisional application No. 60/801,654, filed on May 19, 2006.

(51) Int. Cl. B01J 19/08

(52) U.S. Cl. 204/157.15; 422/186.05

(57) ABSTRACT

A method for the controlled release of an agent (e.g., a biomolecule or nanoparticle) into a specified environment, includes the steps of: (a) providing an electrode or array of electrodes, (b) functionalizing the electrode's surface by introducing to it a molecule or molecules (e.g., thiols on a gold electrode) that chemically bond on the electrode surface and form themselves into a self-assembled monolayer (c) attaching or linking said agent to the molecules through a chemical (e.g., using a coupling group such as amine) or electrostatic (e.g., when the agent is DNA) linkage, and (d) electrochemically releasing the agent from the electrode surface.

### CROSS-REFERENCE TO RELATED APPLICATION

This application claims the benefit of U.S. Provisional Patent Application No. 60/801,654 filed May 19, 2006 by the present inventors.

### STATEMENT AS TO FEDERALLY SPONSORED RESEARCH

This invention was made, in part, with Government support under National Science Foundation Grant No. DMR05-20491. The Government may have certain rights in this invention.

### BACKGROUND OF THE INVENTION

1. Field of the Invention

This invention relates to means that are capable of providing for the controlled release of small quantities of an agent into a specified environment. More particularly, the present invention relates to devices and methods for the electrochemically programmed release of immobilized small molecules (e.g. drugs), biopolymers (e.g. peptides, proteins, DNA), protein assemblies (e.g. viruses), nanoparticles (e.g. particle-DNA conjugates), and microparticles, or combinations thereof, etc. from a situation in which they were previously anchored to lithographically pattered electrode arrays.

2. Description of Prior Art

Many applications in science and engineering require the controlled, both temporal and spatial, release of very small quantities of agents such as molecules or particle conjugates into a specified environment. For example, such applications are often encountered in the bio-sensor, pharmaceutical and chemical-synthesis industries, and especially in the fabrication of controlled drug release devices, gene expression platforms, programmable DNA/protein arrays, protein purification systems, lab-on-a-chip devices and micro-reactors, etc.

Current approaches for such controlled release of molecules or particle conjugates include microfluidic arrays, encapsulated polymers, and microfabricated reservoirs with dissolvable lids.

The devices that are currently being used in these areas have their disadvantages. For example, they are often economically unviable because of their one-time use, and they often provide little flexibility in the control of the rate, amount, type and time of release of the molecules or nanoparticles.

Thus, despite much prior art in these areas, there still exists a need for further improvements to the methods and devices used in these areas.

3. Objects and Advantages

There has been summarized above, rather broadly, the background that is related to the present invention in order that the context of the present invention may be better understood and appreciated. In this regard, it is instructive to also consider the objects and advantages of the present invention.

It is an object of the present invention to provide a reusable, more cost-effective device that can provide for the controlled release of small or ultra-low quantities of a previously immobilized agents (i.e., small molecules (e.g. drugs), biopolymers (e.g. peptides, proteins, DNA), protein assemblies (e.g. viruses), and nanoparticles (e.g. particle-DNA conjugates) or combinations thereof) into a specified environment.

Another object of the present invention is to provide improved controlled release devices that can be integrated into lab-on-a-chip and microfluidic platforms for fundamental research, diagnostic and therapeutic applications.

A further object of the present invention is to provide improved methods for yielding the temporally programmed and spatially coordinated release of very low quantities (down to fentomolar concentrations) of multiple types of biomolecules, nanoparticles, microparticles or combinations thereof.

These and other objects and advantages of the present invention will become readily apparent as the invention is better understood by reference to the accompanying summary, drawing and the detailed description that follows.

### SUMMARY OF THE INVENTION

Recognizing the needs for the development of improved methods and devices for yielding the programmed and spatially coordinated release of very low quantities of biomolecules and nanoparticles, the present invention is generally directed to satisfying these needs.

In a first preferred embodiment, the present invention takes the form of a method for the controlled release of an agent (e.g., a biomolecule or nanoparticle) which includes the steps of: (a) providing an electrode or array of electrodes, (b) functionalizing the electrode's surface by introducing to it a molecule or molecules (e.g., thiols on a gold electrode) that chemically bond on the electrode surface and form themselves into a self-assembled monolayer (c) attaching or linking said agent to the molecules through a chemical (e.g., using a coupling group such as amine) or electrostatic (e.g., when the agent is DNA) linkage, and (d) electrochemically releasing the agent from the electrode surface.

In a second preferred embodiment, the present invention takes the form of a device for the controlled release of such an agent. It includes: (a) an electrode or array of electrodes, (b) a molecule that chemically binds to the electrode surface to form a self-assembled monolayer, and (c) the agent coupled to the molecule and thereby immobilized on the electrode's surface until its user elects to electrochemically release the agent from the electrode surface.

Thus, there has been summarized above, rather broadly, the present invention in order that the detailed description that follows may be better understood and appreciated. There are, of course, additional features of the invention that will be described hereinafter and which will form the subject matter of the eventual claims to this invention.

### BRIEF DESCRIPTION OF THE DRAWINGS

FIG. 1 schematically illustrates the device and some of the processes of the present invention: (a) surface functionalization, (b) loading of agent, and (c) electrochemically programmed release.

### DETAILED DESCRIPTION OF THE PREFERRED EMBODIMENT

Before explaining at least one embodiment of the present invention in detail, it is to be understood that the invention is not limited in its application to the details of examples given below. The invention is capable of other embodiments and of being practiced and carried out in various ways. Also, it is to be understood that the phraseology and terminology employed herein are for the purpose of description and should not be regarded as limiting.

Disclosed herein is a new technique that exploits the formation of self-assembled monolayers (SAM) of a molecule or molecules 10 with strong surface interactions on electrodes 12 and allows for the temporally- and spatially-controlled release of small quantities of agents 3 that can be suitably coupled to such molecules. This new technique, electrochemically programmed release, and our devices 1 which utilize it have application for the controlled release of immobilized small molecules (e.g. drugs), biopolymers (e.g. peptides, proteins, DNA), protein assemblies (e.g. viruses), and nanoparticles (e.g. particle-DNA conjugates), etc.

Since the agents 3 are anchored to an electrode surface via a monolayer, patterning techniques can be used on the electrode 12 to provide for the spatial control of the agent's release via desorption of the molecule 10 at very low electrical currents (e.g., biologically safe levels). Additionally, the electrodes of the present invention can be regenerated and hence our devices can be used for multiple release cycles.

Our technique functionalizes the electrode surface by introducing to it a molecule 10 (e.g., a thiol on gold) that forms a chemical bond with the electrode surface. Chemical (e.g., via a coupling group 14 (e.g., amine)) or electrostatic linkages are then used to attach the to-be-released agent to the molecule, thereby immobilizing the agent and tethering it to the electrode surface.

To further enhance or make possible such a chemical linkage, one may also use a receptor 16 (e.g., biotin) that links to the agent and has a terminal group 18 (e.g., a succinimide group) chosen so as to aid in the coupling with the bonding molecule 10. With such a receptor 16, one may also utilize a variable length spacer 20 which may include a cleavable (e.g., disulfide) or biodegradable (e.g., ester) group to facilitate the further dissociation of the agent (e.g., biomolecule or particle) from the desorbed complex. In other situations, one may conjugate the agent with a material 22 (e.g., a nanoparticle conjugated with avidin) so as provide for its necessary linkage and coupling.

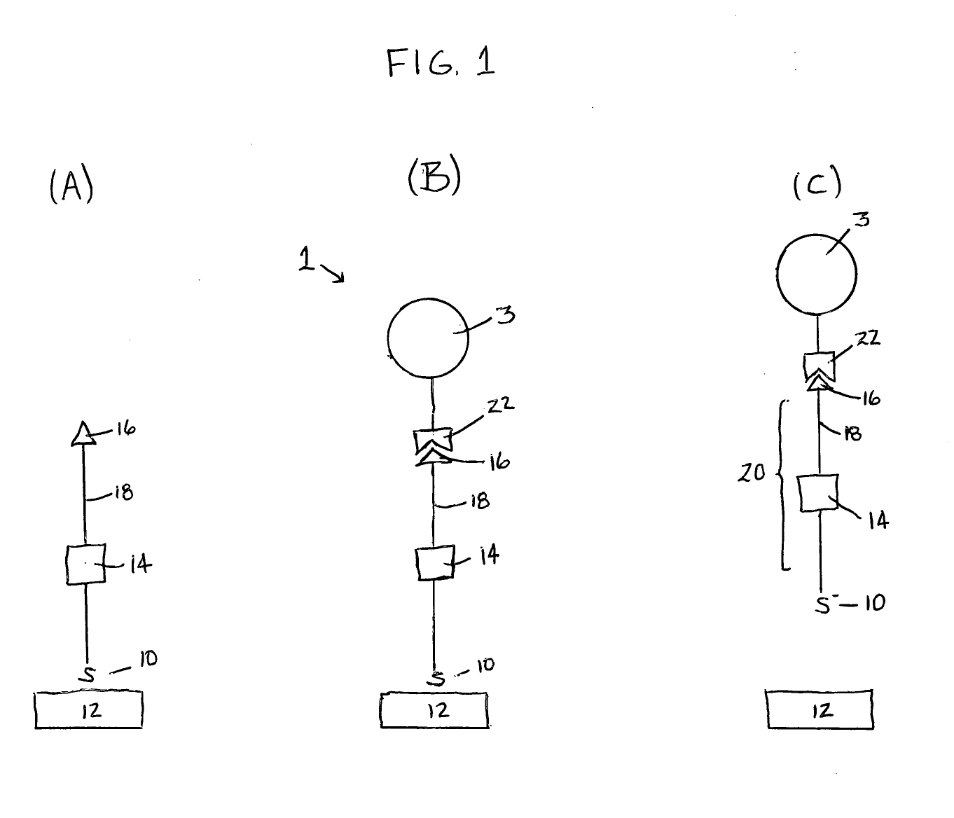

FIG. 1 schematically illustrates the some of the processes for the construction of the device of present invention: (a) electrode surface functionalization, including provisions for a coupling group 14, receptor 18 and spacer 20, (b) loading of an agent 3; followed by the (c) electrochemically programmed release of the agent. Later, the electrode 12 can be regenerated.

By utilizing appropriate materials and fabrication techniques and methods, the devices 1 of the present invention can made such that they have a wide range of combinations of the following characteristics: very small, low-power consumption, low cost, easy to load with a wide range of desired agents, reusable, relatively fast response times, no moving parts, and can be made bio-compatible.

A first example which illustrates the methods and device of the present invention involves the controlled release of a protein from a gold electrode. In this example, it is wished to have a spatially controlled release at a prescribed time of the glycoprotein avidin into a phosphate buffered saline (PBS, Invitrogen), which has a pH in the range of 7.4-8.4, so as to achieve an ultralow (fentomolar) concentration of avidin in solution.

It is also desired to study the kinetics of this process. To accomplish this, we used a rhodamine-conjugated avidin which, by the presence of the rhodamine (a fluorine dye), has the property that its presence when attached to the electrode can be detected by taking fluorescence images of the electrode. The intensity of the fluorescence of the electrode is taken as a measure of the avidin which is initially linked and then subsequently released from the electrode.

A suitable electrode for this illustrative example, and in view of our interest in studying the kinetics of the process, takes the form of 5×2 arrays of gold electrodes that can be fabricated by optical lithography. Each electrode is 100 μm×100 μm and individually connected to a contact pad via a 40 μm wide interconnect. The electrodes are separated by 100 μm. The array can be fabricated from a 100 nm Au film evaporated onto a 75 mm×50 mm microscope glass slide with a 10 nm Cr adhesion layer. Prior to their use, these electrode arrays are immersed in piranha solution (3:1 H₂SO₄:H₂O₂) for 15-30 minutes, followed by sequential rinsing in deionized water and ethanol (ACS/USP, Pharmco), and finally dried under nitrogen.

The present invention's process of forming an electrochemically reversible bond between the desired agent to-be-released (e.g., avidin) and the surface of the electrode requires a few steps. First, for the electrode array described above, a suitable bonding molecule having a suitable coupling group (e.g., amine) is formed in a self-assembled monolayer (SAM) on the surface by placing 1 mL of 1 mM 11-amino-1-undecane-thiol hydrochloride (Dojindo) in DMSO (ACS, Fischer) on the gold array. After two hours, the array was rinsed in ethanol and dried under nitrogen.

The thiol bond is strong but is electrochemically reversible and hence can be electrochemically desorbed from the gold surface at a sufficiently negative potential. The potential at which desorption occurs is dependent on the chain length and the nature of the tail group, as well as on pH.

Next, to provide a suitable receptor (succinimide terminated with biotin) for the to-be-released agent (avidin), 1 mL of 5 mM succinimidyl-6-(biotinamido)-6-hexanamidohexanoate (EZ-link NHS-LC-LC-Biotin, Pierce) in a 1:9 DMSO:PBS solution was dispensed on the array for two hours. This reaction was carried out at pH 7.4, so that the fraction of reactive (unprotonated) amine groups was relatively small (˜1 in 200), resulting in a mixed monolayer of biotin-terminated thiol and amine-terminated thiol. The average area per biotin-terminated thiol in the mixed monolayer is approximately equal to the projected area of avidin. This was followed by a phosphate buffered saline (PBS, Invitrogen) rinse to remove any unreacted biotin linkers.

Finally, the fluorescently-labeled avidin (NeutrAvidin, Invitrogen) was attached to the self-assembled monolayer (SAM) of amine terminated thiol using a 0.1 mg mL⁻¹ PBS solution for 10 minutes to 2 hours (kinetic studies).

The biotin-avidin linkage is one of the strongest known biological interactions with a binding constant of 10⁻¹⁵ M⁻¹ and stability over a broad pH range. Using the device or platform described above, biotinylated polymers, proteins, and peptides can similarly be tethered and released in a controlled manner.

To bring about the electrochemical desorption of the SAM for the programmed release of the immobilized avidin, the electrodes of the array were biased at −1.5 V (vs. Ag/AgCL) for 90 seconds. This resulted in the desorption of the SAM and its diffusion into the bulk solution.

To visualize this controlled release phenomena, an eight member array was used and the −1.5 V bias was applied to only two of the arrays. Fluorescence images of the eight member array showed that the outline of the arrays, to which no bias was applied, could be clearly seen in the images because the fluorescently-labeled avidin was still attached to them. Meanwhile, the arrays to which the bias had been applied, SO as to cause the desorption of the SAM with its linked fluorescently-labeled avidin, were no longer visible in these fluorescence images. See the inventors' documentation of this phenomena in “Electrochemically Programmed Release of Biomolecules and Nanoparticles,” Nano Letters, ACS, vol. 6, no. 6, pp. 1250-1252 (2006).

A second example which illustrates the methods and device of the present invention involved the controlled release of a nanoparticle. In this example, it is again wished to have a spatially controlled release at a prescribed time of 40 nm polystyrene particles so as to achieve an ultralow (fentomolar) concentration of nanoparticles in solution. This is accomplished by conjugating these nanoparticles with fluorescently-labeled avidin (again, so as to visualize the process and study its kinetics) and using a similar electrode array and the functionalization or preparation of its surface as previously described in our first example.

Application of a similar bias to one of the arrays was seen to release the conjugated nanoparticles from the electrode and to result in a loss of its visibility in fluorescence images of the electrode, while the other arrays, which received no current, remained visible due the continued attachment of the fluorescently-labeled avidin conjugated nanoparticles to the electrode.

We have also performed experiments in a two-electrode configurations that would be convenient for standalone microfluidic and drug release devices. For a protein array device with a platinum counter electrode, the onset of the decrease in fluorescence occurred at −2.5 V, and a voltage of −2.7 V for about 30 seconds was sufficient to completely remove the chemisorbed SAMs.

These examples mimic carriers for gene delivery that are often polycationic complexes or nanoparticles with surface amine moieties, and also vehicles for encapsulated small molecules—here fluorescent dyes and proteins, but which could also be drugs and catalytic compounds.

Since proteins and hydrophobic molecules tend to bind non-specifically to gold surfaces, control experiments were performed on unmodified gold electrodes. The extent of avidin immobilization due to non-specific binding on bare gold was negligible compared to functionalized surfaces, and from the fluorescence images there was no evidence of electrochemical desorption, thereby highlighting the specificity of electrode loading and release. Non-specific binding of nanoparticles was more extensive, however, it was minimized by suspending the particles in PBS with a 1% bovine solution which blocked the hydrophobic domains and hence enabled complete desorption from the electrodes.

The electrochemical desorption process of the present invention results in recovery of the bare gold electrode surface, thus facilitating regeneration of the device as well as allowing sequential loading of different molecules and nanoparticles on the different arrays of a complex electrode. The ability to regenerate the electrodes makes this technique a versatile tool for both programmed capture and release of multiple molecules and/or carriers from individually addressable electrode arrays.

Although the foregoing disclosure relates to preferred embodiments of the invention, it is understood that these details have been given for the purposes of clarification only. Various changes and modifications of the invention will be apparent, to one having ordinary skill in the art, without departing from the spirit and scope of the invention.

We claim:

1. A method for the controlled release of an agent into a desired environment, said method comprising the steps of:
providing an electrode having an exterior surface selected for compatibility with said environment,
functionalizing said electrode surface by introducing to said surface a molecule that chemically bonds and forms a self-assembled monolayer on said electrode surface,
linking said agent to said molecule by a linkage chosen from the group comprising chemical or electrostatic linkages, and
electrochemically releasing said agent into said environment.

2. The method as recited in claim 1, wherein:
said electrochemical releasing entails breaking said chemical bond between said molecule and said electrode surface.

3. The method as recited in claim 1, wherein:
said functionalizing of said electrode surface further includes introducing a coupling group to said electrode surface and whereby said coupling group chosen so as to aid in linking said agent to said molecule.

4. The method as recited in claim 2, wherein:
said functionalizing of said electrode surface further includes introducing a coupling group to said electrode surface and whereby said coupling group chosen so as to aid in linking said agent to said molecule.

5. The method as recited in claim 3, wherein:
said functionalizing of said electrode surface further includes introducing a receptor to said electrode surface and whereby said receptor chosen so as to further aid in linking said agent to said molecule.

6. The method as recited in claim 4, wherein:
said functionalizing of said electrode surface further includes introducing a receptor to said electrode surface and whereby said receptor chosen so as to further aid in linking said agent to said molecule.

7. The method as recited in claim 1, wherein:
said chemical bond includes a cleavable bond.

8. The method as recited in claim 3, wherein:
said chemical bond includes a cleavable bond.

9. The method as recited in claim 1, further including the step of:
conjugating said agent with a material chosen so as to aid in linking said agent to said molecule.

10. The method as recited in claim 3, further including the step of:
conjugating said agent with a material chosen so as to aid in linking said agent to said molecule group.

11. The method as recited in claim 1, wherein:
said agent is chosen from the group consisting of molecules, biopolymers, protein assemblies, nanoparticles and microparticles, or combinations thereof.

12. The method as recited in claim 3, wherein:
said agent is chosen from the group consisting of molecules, biopolymers, protein assemblies, nanoparticles and microparticles, or combinations thereof.

13. A device for the controlled release of an agent into a desired environment, said device comprising:
an electrode having an exterior surface,
a molecule introduced to said surface that functionalizes said electrode surface by chemically bonding and forming a self-assembled monolayer on said electrode surface, and
a linking mechanism, chosen from the group comprising chemical or electrostatic linkages, that aids in linking said agent to said molecule.

14. The device as recited in claim 13, wherein:
said linking mechanism includes a coupling group.

15. The device as recited in claim 14, wherein:
said linking mechanism further includes a receptor chosen so as to further aid in linking said agent to said molecule.

16. The device as recited in claim 13, further including:
said agent linked to said molecule for later release by a user of said device.

17. The device as recited in claim 14, further including:
said agent linked to said molecule for later release by a user of said device.

18. The device as recited in claim 15, further including:
said agent linked to said molecule for later release by a user of said device.

19. The device as recited in claim 13, wherein:
said chemical bonding of said molecule includes a cleavable bond.

20. The device as recited in claim 16, wherein:
said chemical bonding of said molecule includes a cleavable bond.

21. The device as recited in claim 16, further including:
a material that conjugates said agent so as to aid in linking said agent to said molecule.

22. The device as recited in claim 16, wherein:
said agent is chosen from the group consisting of molecules, biopolymers, protein assemblies, nanoparticles and microparticles, or combinations thereof.

23. The device as recited in claim 17, wherein:
said agent is chosen from the group consisting of molecules, biopolymers, protein assemblies, nanoparticles and microparticles, or combinations thereof.

24. The device as recited in claim 18, wherein:
said agent is chosen from the group consisting of molecules, biopolymers, protein assemblies, nanoparticles and microparticles, or combinations thereof.
